(19) United States
(12) Patent Application Publication
(10) Pub. No.: US 2004/0240864 A1
(43) Pub. Date: Dec. 2, 2004

(54) Sauna far infrared heat emitting article and method

(76) Inventor: Chang Hwan Lee, Cerritos, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/449,850

(22) Filed: May 30, 2003

(51) Int. Cl. F26B 19/00; A21B 2/00

(52) U.S. Cl. 392/416

(57) ABSTRACT

A far infrared heat emitting article for a sauna. The article disburses far infrared heat substantially evenly, with reduced heat discharge, at a lower surface temperature, and at a longer wavelength and a lower voltage.

### BACKGROUND OF THE INVENTION

1. Field of the Invention

The present invention relates generally to far infrared heaters, and, more particularly, relates to a far infrared heat emitting article and method for a sauna.

2. Description of Related Art

Conventional heaters for saunas include a heating element which includes a resistor wire packed with silicon sand, inside a steel tube. The heating element heats up the pipe. Rocks are placed on the heating element, producing infrared radiant heat by heating the rocks. Heat is provided by convection by superheating the air. Such heaters operated at reduced heater wattage to simulate the far infrared wavelength, but the small surface area thereof prevented generating the desired wavelength. Also, the infrared energy emitted thereby traveled in a straight line, which was inefficient. Further, such heaters took longer to generate heat and required substantial energy therefor.

Infrared heaters for saunas include a heating element inside a steel pipe, wherein the heating element includes a resistor wire packed in silicon sand. The steel pipe is carbon coated to produce infrared heat. A reflector consisting of an aluminum or metal sheet is positioned behind the heater, to increase the heat generated and to produce heat evenly. However, the surface temperature of such heaters is very high, inhibiting the user from getting close thereto.

Ceramic heaters for producing infrared include a heating element inside a ceramic pipe, and include a reflector to produce heat evenly. Such heaters however also generate very high surface temperatures, and are very fragile.

Therefore, there has existed a need for an article which is capable of evenly disbursing far infrared heat for a sauna at a longer wavelength and a lower wattage, with reduced heat discharge and at a lower surface temperature. The present invention fulfills these needs.

### SUMMARY OF THE INVENTION

Briefly, and in general terms, the present invention provides far infrared heat for a sauna over a large surface area, at a low surface temperature, to produce longer wavelength energy.

The article emits far infrared heat for a sauna. It includes a heating element, for emitting heat in the far infrared range. It also includes a supporting-encapsulating element, for supporting the heating element thereon and for encapsulating the heating element therein, which is able to distribute the far infrared heat substantially evenly thereover. It further includes a heat-dispersing coating, for coating the supporting-encapsulating element, which is able to substantially evenly disperse the emitted far infrared heat therefrom.

One aspect of the present invention is that the article disperses far infrared heat substantially evenly from the heating element through the supporting-encapsulating element and the heat-dispersing coating. The heat-dispersing coating also reduces the heat discharge on the supporting-encapsulating element.

Another aspect of the present invention is that the article disperses the far infrared heat at a lower wattage and at a longer wavelength, and the surface temperature on the heat-dispersing coating is lower.

Other features and advantages will become apparent from the following detailed description, taken in conjunction with the accompanying drawings, which describe and illustrate, by way of example, the features of the invention.

### BRIEF DESCRIPTION OF THE DRAWINGS

FIG. 1 is an exploded perspective view of a sauna including multiple far infrared heat emitting articles in housings in accordance with the present invention.

FIG. 2 is a front elevational view of a far infrared heat emitting article in accordance with the present invention.

FIG. 3 is a cross-sectional view of a far infrared heat emitting article in accordance with the invention.

FIG. 4 is a front partly-fragmentary elevational view of a far infrared heat emitting article in a housing in accordance with the invention.

FIG. 5 is a cross-sectional view of a heating element for a far infrared heat emitting article in accordance with the invention.

### DETAILED DESCRIPTION OF THE PREFERRED EMBODIMENTS

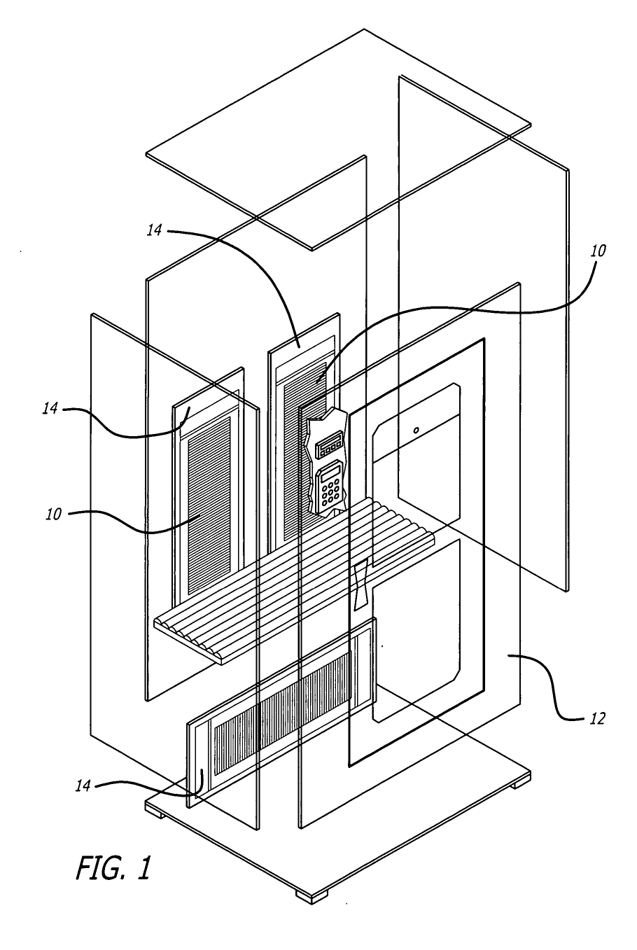

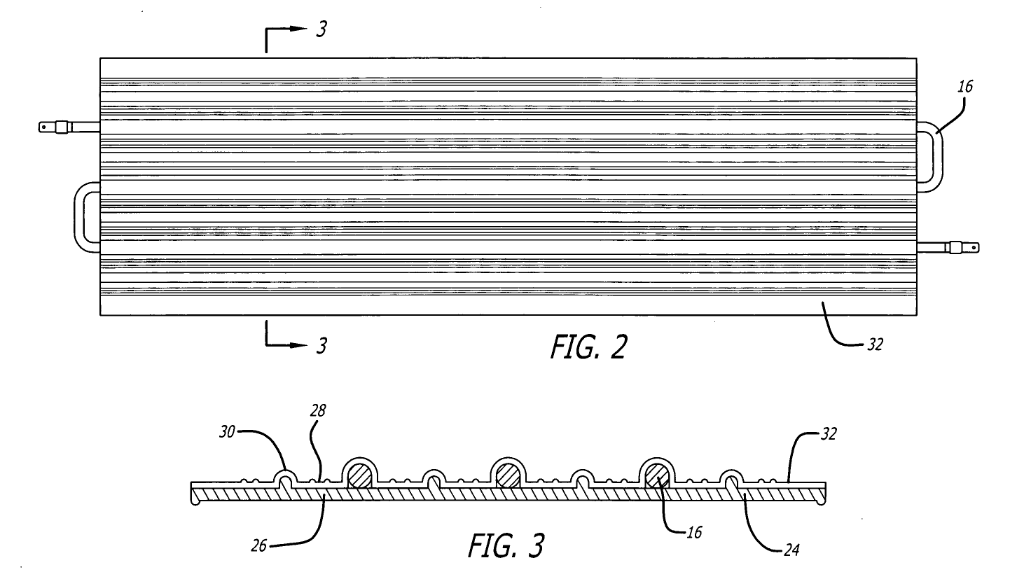

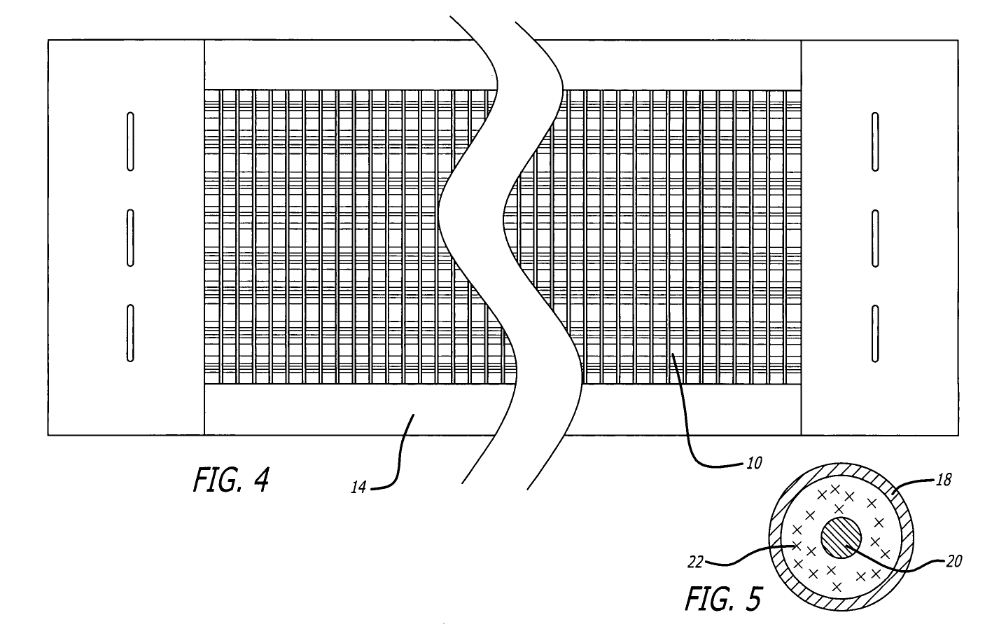

Referring to the drawings, and in particular to FIGS. 1-5, there is shown an article 10 for emitting far infrared heat for a sauna 12. In FIGS. 1 and 4, the article 10 is mounted in a housing 14. The far infrared heat is emitted by the article 10 at a substantially long wavelength, and is generated at a substantially low wattage. The wavelength of the far infrared heat emitted by the article 10 is also substantially close to the wavelength of the far infrared heat emitted by the human body. Further, the far infrared heat is emitted thereby at a substantially low surface temperature. Also, the article 10 is able to emit a substantial amount of far infrared heat. The emitted far infrared heat is further able to be sensed by the user relatively rapidly. The article 10 is further able to provide a substantial radiating surface area for emitting far infrared heat substantially evenly therefrom. The article 10 in the housing 14 is also able to be surface mounted in the sauna 12.

The article 10 includes a heating element 16, for emitting heat in the far infrared range. The heating element 16 comprises a hollow tube 18, which includes a resistor wire 20 therein. The hollow tube 18 is comprised of metal. The resistor wire 20 is packed in silicone sand 22 in the hollow tube 18. The article further includes a supporting-encapsulating element 24, for supporting the heating element 16 thereon and for encapsulating the heating element 16 therein, which is able to distribute the far infrared heat substantially evenly thereover. The supporting-encapsulating element 24 includes a base layer 26 for supporting the heating element 16, and an encapsulating layer 28 for encapsulating the heating element 16. The base layer 26 includes projecting portions 30 which are projecting therefrom, and which are able to reflect and fan out the emitted far infrared heat. The supporting-encapsulating element 24 is comprised of aluminum and metal. The article also includes a heat-dispersing coating 32, for coating the supporting-encapsulating element 24, which is able to substantially evenly disperse the emitted far infrared heat therefrom. The heat-dispersing coating 32 is further able to reduce the heat discharge on the supporting-encapsulating element 24. The heat-dispersing coating 30 is comprised of ceramic.

As illustrated in FIGS. 1-5, in a method for use of the article 10, heat is emitted in the far infrared range by the heating element 16, the far infrared heat is distributed substantially evenly thereover by the supporting-encapsulating element 24, and the emitted far infrared heat is disbursed therefrom by the heat-dispersing element 32. Heat is emitted by the article 10 in the wavelength of the far infrared heat substantially close to the wavelength of the far infrared heat emitted by the human body. Heat is further emitted thereby at a substantially low surface temperature. A substantial amount of far infrared heat is emitted thereby. The far infrared heat emitted by the article 10 is able to be sensed by the user relatively rapidly. The far infrared heat is emitted by the article 10 at a substantially long wavelength and is generated at a substantially low wattage.

The heating element 16 is supported and encapsulated in the supporting-encapsulating element 24, for enabling the article 10 to distribute the far infrared heat emitted by the heating element 16 substantially evenly over the supporting-encapsulating element 24. A substantial radiating surface area is provided by the supporting-encapsulating element 24 for emitting the far infrared heat. The article 10 is enabled to be surface mounted in the sauna 12 by the supporting-encapsulating element 24. The hollow tube 18 of the heating element 16, including the resistor wire 20 packed in silicon sand 22, is supported and encapsulated by the supporting-encapsulating element 24.

The heating element 14, which includes the metal hollow tube 18, is supported by the base layer 26 of the supporting-encapsulating element 24 which is comprised of metal, and is encapsulated by the encapsulating layer 28 thereof. The emitted far infrared heat is reflected and fanned out by the projecting portions 30 in the base layer 26 of the supporting-encapsulating element 24. The supporting-encapsulating element 24 is coated by the heat-dispersing coating 32, for enabling the article 10 to emit heat in the far infrared range, and to substantially evenly disperse the emitted far infrared heat. The heat discharge of the article 10 is reduced by the heat-dispersing coating 32, which is comprised of ceramic, on the supporting-encapsulating element 24.

From the foregoing it will be appreciated that the system of the present invention provides advantages in far infrared heat emitting articles which are able to be surface mounted in saunas, and which emit a substantial amount of such heat, at a substantially long wavelength close to the wavelength thereof emitted by the human body, and at a substantially low surface temperature, from a substantial radiating surface area, and generated at a substantially low wattage. While several particular forms of the invention have been illustrated and described, it will be apparent that various modifications can be made without departing from the spirit and scope of the invention. Accordingly, the invention is not to be limited, except as by the following claims.

What is claimed is:

1. An article for emitting far infrared heat for a sauna, comprising:
a heating element, for emitting heat in the far infrared range;
a supporting-encapsulating element, for supporting the heating element thereon and for encapsulating the heating element therein, adapted to distribute the far infrared heat substantially evenly thereover; and
a heat-dispersing coating, for coating the supporting-encapsulating element, adapted to substantially evenly disperse the emitted far infrared heat therefrom.

2. The article of claim 1, wherein the wavelength of the far infrared heat emitted thereby is substantially close to the wavelength of the far infrared heat emitted by the human body.

3. The article of claim 1, further adapted to provide a substantial radiating surface area for the emitted far infrared heat.

4. The article of claim 1, wherein the far infrared heat is emitted thereby at a substantially low surface temperature.

5. The article of claim 1, adapted to emit a substantial amount of far infrared heat.

6. The article of claim 1, wherein the emitted far infrared heat is adapted to be sensed by the user relatively rapidly.

7. The article of claim 1, further adapted to be surface mounted in the sauna.

8. The article of claim 1, wherein the far infrared heat is emitted at a substantially long wavelength, and is generated at a substantially low wattage.

9. The article of claim 1, wherein the heat-dispersing coating is further adapted to reduce the heat discharge on the supporting-encapsulating element.

10. The article of claim 1, wherein the heating element comprises a hollow tube, which includes a resistor wire therein.

11. The article of claim 1, wherein the supporting-encapsulating element includes a base layer for supporting the heating element, and an encapsulating layer for encapsulating the heating element.

12. The article of claim 1, wherein the supporting-encapsulating element is comprised of metal.

13. The article of claim 1, wherein the heat-dispensing coating is comprised of ceramic.

14. The article of claim 10, wherein the hollow tube is comprised of metal.

15. The article of claim 10, wherein the resistor wire is packed in silicone sand in the hollow tube.

16. The article of claim 11, wherein the base layer includes projecting portions which are projecting therefrom, adapted to fan out and reflect the emitted far infrared heat.

17. An article for emitting far infrared heat for a sauna, comprising:
heating means, for emitting heat in the far infrared range;
supporting-encapsulating means, for supporting the heating element thereon and for encapsulating the heating means therein, adapted to distribute the far infrared heat substantially evenly thereover; and
heat-dispersing means, for coating the supporting-encapsulating means, adapted to substantially evenly disperse the emitted far infrared heat therefrom.

18. A method of emitting far infrared heat for a sauna, in an article which comprises a heating element, for emitting heat in the far infrared range, a supporting-encapsulating element, for supporting the heating element thereon and for encapsulating the heating element therein, adapted to distribute the far infrared heat substantially evenly thereover, and a heat-dispersing coating, for coating the supporting-encapsulating element, adapted to substantially evenly disperse the emitted far infrared heat therefrom, wherein the method comprises:
supporting and encapsulating the heating element in the supporting-encapsulating element, for enabling the article to distribute the far infrared heat emitted by the heating element substantially evenly over the supporting-encapsulating element; and
coating the supporting-encapsulating element in the heat-dispersing coating, for enabling the article to emit heat in the far infrared range, and to substantially evenly disperse the emitted far infrared heat.

19. The method of claim 18, further comprising emitting heat in the far infrared range by the heating element, distributing the far infrared heat substantially evenly thereover by the supporting-encapsulating element, and substantially evenly dispersing the emitted far infrared heat therefrom by the heat-dispersing element.

20. The method of claim 18, further adapted to provide a substantial radiating surface area for the emitted far infrared heat, wherein supporting and encapsulating further comprises providing a substantial radiating surface area for the emitted far infrared heat.

21. The method of claim 18, further adapted to be surface mounted in the sauna, and wherein supporting and encapsulating further comprises enabling the article to be surface mounted in the sauna.

22. The method of claim 18, wherein the heat-dispersing coating is further adapted to reduce the heat discharge on the supporting-encapsulating element, and wherein coating further comprises reducing the heat discharge on the supporting-encapsulating element.

23. The method of claim 18, wherein the heating element comprises a hollow tube, which includes a resistor wire therein, and wherein supporting and encapsulating further comprises supporting and encapsulating the hollow tube including the resistor wire therein.

24. The method of claim 18, wherein the supporting-encapsulating element includes a base layer for supporting the heating element, and an encapsulating layer for encapsulating the heating element, and wherein supporting and encapsulating further comprise supporting the heating element by the base layer, and encapsulating the heating element by the encapsulating layer.

25. The method of claim 18, wherein the supporting-encapsulating element is comprised of metal, and wherein supporting and encapsulating further comprises supporting and encapsulating by the metal supporting-encapsulating element.

26. The method of claim 18, wherein the heat-dispensing coating is comprised of ceramic, and wherein coating further comprises coating by the ceramic coating.

27. The method of claim 19, wherein the wavelength of the far infrared heat emitted thereby is substantially close to the wavelength of the far infrared heat emitted by the human body, and wherein emitting further comprises emitting heat in the wavelength of the far infrared heat substantially close to the wavelength of the far infrared heat emitted by the human body.

28. The method of claim 19, wherein the far infrared heat is emitted thereby at a substantially low surface temperature, and wherein emitting further comprises emitting heat at a substantially low surface temperature.

29. The method of claim 19, adapted to emit a substantial amount of far infrared heat, and wherein emitting comprises emitting a substantial amount of far infrared heat.

30. The method of claim 19, wherein the emitted far infrared heat is adapted to be sensed by the user relatively rapidly, further comprising enabling the emitted far infrared heat to be sensed by the user relatively rapidly.

31. The method of claim 19, wherein the far infrared heat is emitted at a substantially long wavelength, and is generated at a substantially low wattage, and wherein emitting further comprises emitting the far infrared heat at a substantially long wavelength and generating the far infrared heat at a substantially low wattage.

32. The method of claim 23, wherein the hollow tube is comprised of metal, and wherein supporting and encapsulating further comprises supporting and encapsulating the metal hollow tube.

33. The method of claim 23, wherein the resistor wire is packed in silicone sand in the hollow tube, and wherein supporting and encapsulating further comprises supporting and encapsulating the resistor wire packed in silicon sand in the hollow tube.

34. The method of claim 24, wherein the base layer includes projecting portion s which are projecting therefrom, adapted to fan out and reflect the emitted far infrared heat, and wherein supporting and encapsulating further comprise supporting the heating element on the base layer, and fanning out and reflecting the emitted far infrared heat by the projecting portions in the base layer.

35. A method of emitting far infrared heat for a sauna, in an article which comprises heating means, for emitting heat in the far infrared range, supporting-encapsulating means, for supporting the heating element thereon and for encapsulating the heating means therein, adapted to distribute the far infrared heat substantially evenly thereover, and heat-dispersing means, for coating the supporting-encapsulating means, adapted to substantially evenly disperse the emitted far infrared heat therefrom, wherein the method comprises:
supporting and encapsulating the heating means in the supporting-encapsulating means, for enabling the article to distribute the far infrared heat emitted by the heating means substantially evenly over the supporting-encapsulating means; and
coating the supporting-encapsulating means in the heat-dispersing means, for enabling the article to emit heat in the far infrared range, and to substantially evenly disperse the emitted far infrared heat.
